(19) United States
(12) Patent Application Publication
(10) Pub. No.: US 2023/0361287 A1
(43) Pub. Date: Nov. 9, 2023

(54) SILICON-DOMINANT ELECTRODES FOR ENERGY STORAGE USING WET OXIDIZED SILICON BY ACID

(71) Applicant: ENEVATE CORPORATION, Irvine, CA (US)

(72) Inventors: Rahul Kamath, Misssion Viejo, CA (US); Ian Browne, Orange, CA (US)

(21) Appl. No.: 17/737,372

(22) Filed: May 5, 2022

(51) Int. Cl. H01M 4/48; H01M 10/0525

(52) U.S. Cl. CPC H01M 4/483; H01M 10/0525; H01M 2004/021

(57) ABSTRACT

Systems and methods are provided for silicon-dominant electrodes for energy storage using wet oxidized silicon by acid. Silicon may be treated by wet oxidization treatment using acid. The acid may be a nitric acid. Treated silicon may include silicon particles, with each silicon particle including an oxide surface layer formed as a result of the wet oxidization treatment. The wet oxidization treatment may include immersing untreated silicon powder in an acid, dispersing the silicon power continuously, and after an immersion period of pre-determined duration, filtering the silicon powder from the acid.

### TECHNICAL FIELD

Aspects of the present disclosure relate to energy generation and storage. More specifically, certain implementations of the present disclosure relate to methods and systems for silicon-dominant electrodes for energy storage using wet oxidized silicon by acid.

### BACKGROUND

Various issues may exist with conventional battery technologies. In this regard, conventional systems and methods, if any existed, for designing and producing batteries or components thereof may be costly, cumbersome, and/or inefficient-e.g., they may be complex and/or time consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for silicon-dominant electrodes for energy storage using wet oxidized silicon by acid, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1A illustrates an example battery.

FIG. 1B illustrates an example battery management system (BMS) for use in managing operation of batteries.

FIG. 2 is a flow diagram of an example lamination process for forming a silicon-dominant anode cell.

FIG. 3 is a flow diagram of a direct coating process for forming a silicon-dominant anode cell.

FIGS. 4A and 4B are graph diagrams illustrating X-ray Photoelectron Spectroscopy (XPS) spectra for silicon powders with untreated silicon particles and nitric acid treated silicon particles.

FIG. 5 is a graph diagram illustrating cycling performance of anodes with nitric acid treated silicon particles compared with control anodes when using 4C(4.2V)/0.5C(3.1V) testing regime.

FIG. 6 is a graph diagram illustrating cycling performance of anodes with nitric acid treated silicon particles compared with control anodes when using 1C(4.2V)/0.5C(3.1V) testing regime.

### DETAILED DESCRIPTION

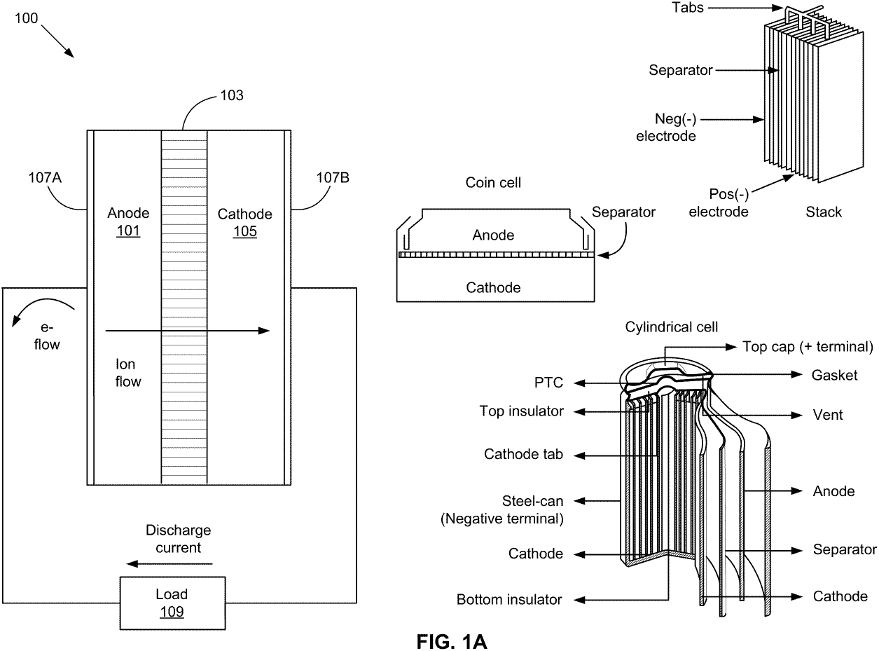

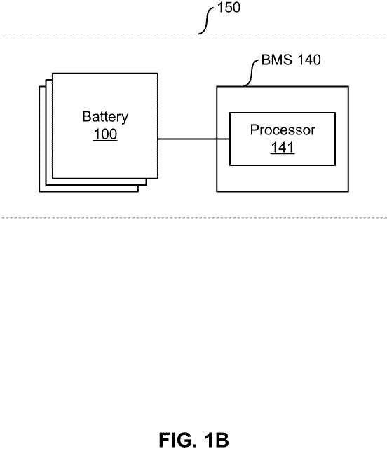

FIG. 1A illustrates an example battery. Referring to FIG. 1A, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack. Furthermore, the battery 100 shown in FIG. 1A is a very simplified example merely to show the principle of operation of a lithium-ion cell. Examples of realistic structures are shown to the right in FIG. 1A, where stacks of electrodes and separators are utilized, with electrode coatings typically on both sides of the current collectors except, in certain cases, the outermost electrodes. The stacks may be formed into different shapes, such as a coin cell, cylindrical cell, prismatic pouch cell, or prismatic metal can cell, for example.

The development of portable electronic devices and electrification of transportation drive the need for high-performance electrochemical energy storage. In devices ranging from small-scale (<100 Wh) to large-scale (>10 kWh), Li ion batteries are widely used over other rechargeable battery chemistries due to their advantages in energy density and cyclability.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode 105 are electrically coupled to the current collectors 107A and 107B, which comprise metal or other conductive material for providing electrical contact to the electrodes as well as physical support for the active material in forming electrodes.

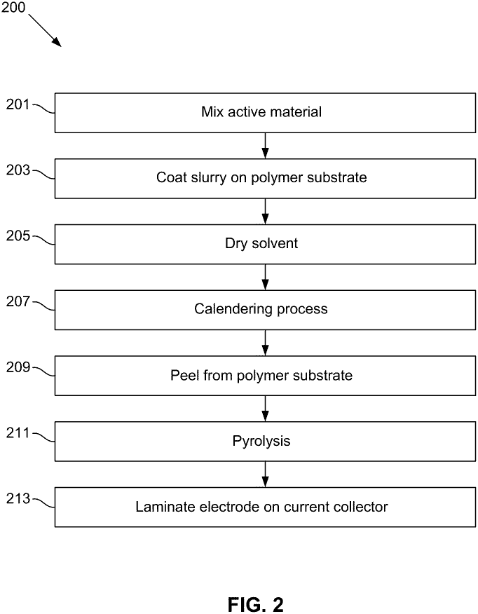

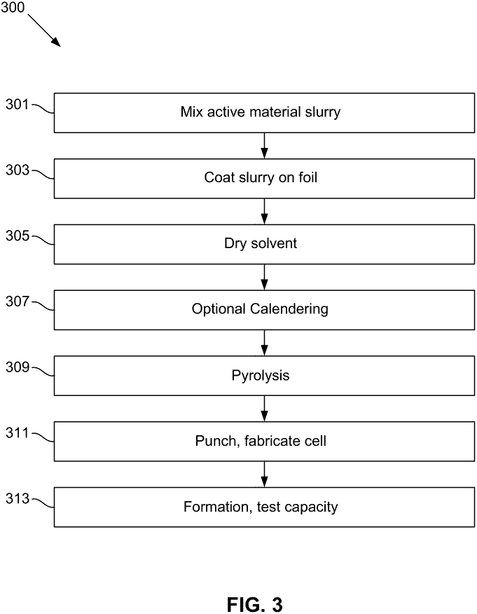

The configuration shown in FIG. 1A illustrates the battery 100 in discharge mode, whereas in a charging configuration, the load 109 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. In this regard, different methods or processes may be used in forming electrodes, particularly silicon-dominant (>50% in terms of active material by capacity or by weight) anodes. For example, lamination or direct coating may be used in forming a silicon-containing anode (silicon anode). Examples of such processes are illustrated in and described with respect to FIGS. 2 and 3. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiCIO₄, LiFSI, LiTFSI, etc. In an example scenario, the electrolyte may comprise Lithium hexafluorophosphate (LiPF₆) and lithium bis(trifluoromethanesulfonyl)imide (LiTFSI) that may be used together in a variety of electrolyte solvents. Lithium hexafluorophosphate (LiPF₆) may be present at a concentration of about 0.1 to 4.0 molar (M) and lithium bis(trifluoromethanesulfonyl)imide (LiTFSI) may be present at a concentration of about 0 to 4.0 molar (M). Solvents may comprise one or more cyclic carbonates, such as ethylene carbonate (EC), fluoroethylene carbonate (FEC), or propylene carbonate (PC) as well as linear carbonates, such as ethyl methyl carbonate (EMC), diethyl carbonate (DEC), and dimethyl carbonate (DMC), in various percentages. In some embodiments, the electrolyte solvents may comprise one or more of EC from about 0-40%, FEC from about 2-40% and/or EMC from about 50-70% by weight.

The separator 103 may be soaked with a liquid or gel electrolyte. In addition, in an example embodiment, the separator 103 does not melt below about 100 to 140° C., and exhibits sufficient mechanical properties for battery applications. A battery, in operation, can experience expansion and contraction of the anode 101 and/or the cathode 105. In an example embodiment, the separator 103 can expand and contract by at least about 5 to 10% without tearing or otherwise failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material and a current collector, such as a copper sheet. Carbon is often used because it has excellent electrochemical properties and is also electrically conductive. Anode electrodes currently used in rechargeable lithium-ion cells typically have a specific capacity of approximately 200 milliamp hours per gram (mAh/g). Graphite, the active material used in most lithium-ion battery anodes, has a theoretical energy density of 372 mAh/g. In comparison, silicon has a high theoretical capacity of 4200 mAh/g. In order to increase volumetric and gravimetric energy density of lithium-ion batteries, silicon may be used as the active material for the cathode 105 or anode 101. Si anodes may be in the form of a composite on a current collector, with >50% Si by capacity or weight in the composite layer.

In an example scenario, the anode 101 and cathode 105 store the ions used for separation of charge, such as lithium ions. In this example, the electrolyte carries positively charged lithium ions from the anode 101 to the cathode 105 in discharge mode, as shown in FIG. 1A, and vice versa through the separator 103 in charge mode. The movement of the lithium ions and reactions with the electrodes create free electrons in one electrode which creates a charge at the opposite current collector. The electrical current then flows from the current collector where charge is created through the load 109 to the other current collector. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 through the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density and high power density of lithium-ion batteries are achieved with the development of high-capacity and high-voltage cathodes, high-capacity anodes and electrolytes with high voltage stability and interfacial compatibility with electrodes. Functionally non-flammable or less-flammable electrolytes could be used to improve safety. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be improved by incorporating conductive additives with different morphological properties. Carbon black (Super P), vapor grown carbon fibers (VGCF), and a mixture of the two have previously been incorporated into the anode to improve electrical conductivity and otherwise improve performance. The synergistic interactions between the two carbon materials may facilitate electrical contact throughout the large volume changes of the silicon anode during charge and discharge as well as provide additional mechanical robustness to the electrode and provide mechanical strength (e.g., to keep the electrode material in place). These contact points (especially when utilizing high-aspect-ratio conductive materials) facilitate the electrical contact between anode material and current collector to mitigate the isolation (island formation) of the electrode material while also improving conductivity in between silicon regions. Graphenes and carbon nanotubes may be used because they may show similar benefits. Thus, in some instances, a mixture of two or more of carbon black, vapor grown carbon fibers, graphene, and carbon nanotubes may be used independently or in combinations for the benefits of conductivity and other performance.

State-of-the-art lithium-ion batteries typically employ a graphite-dominant anode which is a lithium intercalation type anode. Silicon-dominant anodes, however, offer improvements compared to graphite-dominant Li-ion batteries. Silicon exhibits both higher gravimetric (4200 mAh/g vs. 372 mAh/g for graphite) and volumetric capacities (2194 mAh/L vs. 890 mAh/L for graphite). In addition, Si has a higher redox reaction potential versus Li compared to graphite, with a voltage plateau at about 0.3-0.4 V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon’s large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life. Therefore, silicon anodes require a strong conductive matrix that (a) holds silicon particles together in the anode, (b) is flexible enough to accommodate the large volume expansion and contraction of silicon, and (c) allows a fast conduction of electrons within the matrix.

Therefore, there is a trade-off among the functions of active materials, conductive additives and polymer binders. The balance may be adversely impacted by high energy density silicon anodes with low conductivity and huge volume variations described above. Polymer binder(s) may be pyrolyzed to create a pyrolytic carbon matrix with embedded silicon particles. In addition, the polymers may be selected from polymers that are completely or partially soluble in water or other environmentally benign solvents or mixtures and combinations thereof. Polymer suspensions of materials that are non-soluble in water could also be utilized.

In some embodiments, dedicated systems and/or software may be used to control and manage batteries or packs thereof. In this regard, such dedicated systems may comprise suitable circuitry for running and/or executing control and manage related functions or operations. Further, such software may run on suitable circuitry, such as on processing circuitry (e.g., general processing units) already present in the systems or it may be implemented on dedicated hardware. For example, battery packs (e.g., those used in electric vehicles) may be equipped with a battery management system (BMS) for managing the batteries (or packs) and operations. An example battery management system (BMS) is illustrated in and described in more detail with respect to FIG. 1B.

FIG. 1B illustrates an example battery management system (BMS) for use in managing operation of batteries. Shown in FIG. 1B is battery management system (BMS) 140.

The battery management system (BMS) 140 may comprise suitable circuitry (e.g., processor 141) configured to manage one or more batteries (e.g., each being an instance of the battery 100 as described with respect with FIG. 1A). In this regard, the BMS 140 may be in communication and/or coupled with each battery 100. In some implementations, a separate processor (e.g., a conventional processor, such as an electronic control unit (ECU), a microcontroller unit (ECU), or the like), or several such separate processors, may be used, and may be configured to handle algorithms or control functions with regards to the batteries. In such implementations, such processor(s) may be connected to the batteries, such as through the processor 141, and thus may be treated as part of the BMS 140 and acting as part of processor 141.

In some embodiments, the battery 100 and the BMS 140 may be in communication and/or coupled with each other, for example, via electronics or wireless communication. In some embodiments, the BMS 140 may be incorporated into the battery 100. Alternatively, in some embodiments, the BMS 140 and the battery 100 may be combined into a common package 150. Further, in some embodiments, the BMS 140 and the battery 100 may be separate devices/components, and may only be in communication with one another when present in the same system. The disclosure is not limited to any particular arrangement, however.

FIG. 2 is a flow diagram of an example lamination process for forming a silicon-dominant anode cell. This process employs a high-temperature pyrolysis process on a substrate, layer removal, and a lamination process to adhere the active material layer to a current collector. This strategy may also be adopted by other types of anodes, such as graphite, conversion type anodes, such as transition metal oxides, transition metal phosphides, and other alloy type anodes, such as Sn, Sb, Al, P, etc.

To fabricate an anode, the raw electrode active material is mixed in step 201. In the mixing process, the active material may be mixed with a binder/resin (such as water soluble PI (polyimide), PAI (polyamideimide), carboxymethyl cellulose (CMC), styrene-butadiene rubber (SBR), poly(acrylic acid) (PAA), Sodium Alginate, Phenolic or other water soluble resins and mixtures and combinations thereof), solvent, rheology modifiers, surfactants, pH modifiers, and conductive additives. The materials may comprise carbon nanotubes/fibers, graphene sheets, metal polymers, metals, semiconductors, and/or metal oxides, for example. Silicon powder with a 1-30 or 5-30 µm particle size, for example, may then be dispersed in polyamic acid resin, PAI, or PI (15-25% solids in N-Methyl pyrrolidone (NMP) or deionized (DI) water) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30 -40%. The pH of the slurry can be varied from acidic to basic, which may be beneficial for controlling the solubility, conformation, or adhesion behavior of water soluble polyelectrolytes, such as polyamic acid, carboxymethyl cellulose, or polyacrylic acid. Ionic or non-ionic surfactants may be added to facilitate the wetting of the insoluble components of the slurry or the substrates used for coating processes. The particle size and mixing times may be varied to configure the electrode coating layer density and/or roughness.

Furthermore, cathode electrode coating layers may be mixed in step 201, and coated (e.g., onto aluminum), where the electrode coating layer may comprise cathode material mixed with carbon precursor and additive as described above for the anode electrode coating layer. The cathode material may comprise Lithium Nickel Cobalt Manganese Oxide (NMC (also called NCM): LiNiₓCo_{y}Mn_{z}O₂, x+y+z=1), Lithium Iron Phosphate (LFP: LiFePO₄/C), Lithium Nickel Manganese Spinel (LNMO: e.g. LiNi_{0.5}Mn_{1.5}O₄), Lithium Nickel Cobalt Aluminum Oxide (NCA: LiNiₐCo_{b}Al_{c}O₂, a+b+c=1), Lithium Manganese Oxide (LMO: e.g. LiMn2O₄), a quaternary system of Lithium Nickel Cobalt Manganese Aluminum Oxide (NCMA: e.g. Li[Ni_{0.89}Co_{0.05}Mn_{0.05}Al_{0.01}]O₂, Lithium Cobalt Oxide (LCO: e.g. LiCoO₂), and other Li-rich layer cathodes or similar materials, or combinations thereof. The particle size and mixing times may be varied to configure the electrode coating layer density and/or roughness.

In step 203, the slurry may be coated on a substrate. In this step, the slurry may be coated onto a polyester, polyethylene terephthalate (PET), or Mylar film at a loading of, e.g., 2-4 mg/cm² and then undergo drying in step 205 to an anode coupon with high Si content and less than 15% residual solvent content. This may be followed by an optional calendering process in step 207, where a series of hard pressure rollers may be used to finish the film/substrate into a smoothed and denser sheet of material.

In step 209, the active-material-containing film may then be removed from the PET, where the active material layer may be peeled off the polymer substrate. The peeling may be followed by a pyrolysis step 211 where the material may be heated to, e.g., 600-1250° C. for 1-3 hours, cut into sheets, and vacuum dried using a two-stage process (120° C. for 15 h, 220° C. for 5 h). The peeling process may be skipped if polypropylene (PP) substrate is used, and PP can leave ~2% char residue upon pyrolysis.

In step 213, the electrode material may be laminated on a current collector. For example, a 5-20 µm thick copper foil may be coated with polyamide-imide with a nominal loading of, e.g., 0.2-0.6 mg/cm² (applied as a 6 wt% varnish in NMP and dried for, e.g., 12-18 hours at, e.g., 110° C. under vacuum). The anode coupon may then be laminated on this adhesive-coated current collector. In an example scenario, the silicon-carbon composite film is laminated to the coated copper using a heated hydraulic press. An example lamination press process comprises 30-70 seconds at 300° C. and 3000-5000 psi, thereby forming the finished silicon-composite electrode.

The cell may be assessed before being subject to a formation process. The measurements may comprise impedance values, open circuit voltage, and electrode and cell thickness measurements. The formation cycles are defined as any type of charge/discharge of the cell that is performed to prepare the cell for general cycling and is considered part of the cell production process. Different rates of charge and discharge may be utilized in formation steps. During formation, the initial lithiation of the anode may be performed, followed by delithiation. Cells may be clamped during formation and/or cycling.

FIG. 3 is a flow diagram of a direct coating process for forming a silicon-dominant anode cell. This process comprises physically mixing the active material, conductive additive, and binder together, and coating the mixed slurry directly on a current collector before pyrolysis. This example process comprises a direct coating process in which an anode or cathode slurry is directly coated on a copper foil using a binder such as CMC, SBR, PAA, Sodium Alginate, PAI, PI and mixtures and combinations thereof.

In step 301, the active material may be mixed with, e.g., a binder/resin (such as PI, PAI or phenolic), solvent (such as NMP, water, other environmentally benign solvents or their mixtures and combinations thereof), and conductive additives. The materials may comprise carbon nanotubes/fibers, graphene sheets, metal polymers, metals, semiconductors, and/or metal oxides, for example. Silicon powder with a 1-30 µm particle size, for example, may then be dispersed in polyamic acid resin, PAI, PI (15% solids in DI water or N-Methyl pyrrolidone (NMP)) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30 -40%.

Furthermore, cathode active materials may be mixed in step 301, where the active material may comprise lithium cobalt oxide (LCO), lithium iron phosphate, lithium nickel cobalt manganese oxide (NMC), lithium nickel cobalt aluminum oxide (NCA), lithium manganese oxide (LMO), lithium nickel manganese spinel, or similar materials or combinations thereof, mixed with a binder as described above for the anode active material.

In step 303, the slurry may be coated on a copper foil. In the direct coating process described here, an anode slurry is coated on a current collector with residual solvent followed by a drying and a calendering process for densification. A pyrolysis step (~500-800° C.) is then applied such that carbon precursors are partially or completely converted into glassy carbon or pyrolytic carbon. Similarly, cathode active materials may be coated on a foil material, such as aluminum, for example. The active material layer may undergo a drying process in step 305 to reduce residual solvent content. An optional calendering process may be utilized in step 307 where a series of hard pressure rollers may be used to finish the film/substrate into a smoother and denser sheet of material. In step 307, the foil and coating optionally proceeds through a roll press for calendering where the surface is smoothed out and the thickness is controlled to be thinner and/or more uniform.

In step 309, the active material may be pyrolyzed by heating to 500-1000° C. such that carbon precursors are partially or completely converted into glassy carbon. Pyrolysis can be done either in roll form or after punching. If the electrode is pyrolyzed in a roll form, it will be punched into individual sheets after pyrolysis. The pyrolysis step may result in an anode active material having silicon content greater than or equal to 50% by capacity or by weight. In an example scenario, the anode active material layer may comprise 20 to 95% silicon. In another example scenario may comprise 50 to 95% silicon by weight. In instances where the current collector foil is not pre-punched/pre-perforated, the formed electrode may be perforated with a punching roller, for example.. The punched anodes may then be used to assemble a cell with cathode, separator and electrolyte materials. In some instances, separator with significant adhesive properties may be utilized.

In step 313, the cell may be assessed before being subject to a formation process. The measurements may comprise impedance values, open circuit voltage, and cell and/or electrode thickness measurements. During formation, the initial lithiation of the anode may be performed, followed by delithiation. Cells may be clamped during formation and/or early cycling. The formation cycles are defined as any type of charge/discharge of the cell that is performed to prepare the cell for general cycling and is considered part of the cell production process. Different rates of charge and discharge may be utilized in formation steps.

In accordance with the present disclosure, silicon-dominant composite electrodes comprising silicon particles wet oxidized using acid, such as nitric acid, may be utilized in energy storage devices, such as silicon-dominant anode based cells/batteries. In particular, in various implementations based on the present disclosure, silicon used in silicon-dominant electrodes may be pre-treated to enhance performance of the subsequently formed silicon-dominant electrodes, as well as performance of energy storage devices incorporating these electrode, with the pre-treatment specifically comprising oxidization of the silicon particles using acid, particularly nitric acid. In this regard, silicon-carbon composite electrodes comprising silicon particles suspended in a carbon matrix attached to a current collector may provide superior energy density-e.g., compared to graphite electrodes-particularly when paired with high-voltage, high-capacity cathodes, such as NMC, NCA, etc. Such silicon-carbon composite electrodes may also have superior cycle life and initial coulombic efficiency to silicon electrodes comprised of silicon particles, conductive additives, and polymeric binders. As noted, silicon has been considered to replace graphite as active material in lithium-ion battery anodes, as silicon possesses high(er) theoretical capacity (4200 mAh/g).

However, silicon suffers from severe volume fluctuation (e.g., ~300%) during lithiation/de-lithiation (charging/discharging) throughout battery operation. Thus, it may be desirable to use non-elemental silicon that may still possess the desired high theoretical capacity but with less volume fluctuation. For example, silicon oxides with different oxide content have been investigated owing to abundant reserves, low cost, and easy synthesis. In this regard, silicon oxides show smaller volume change during cycling when compared to elemental silicon, which may result in improved battery cycle life by minimizing silicon pulverization and maintaining electrical contact in electrode (anodes). However, silicon oxides are insulators with low electrical conductivity and lower electrochemical activity. The initial coulombic efficiency of silicon oxides is relatively low owing to the formation of inactive phases like lithium oxides and lithium silicates in the first formation cycle. Retaining both the benefits of silicon and silicon oxide is ideal to produce an energy dense yet cyclable anode material.

An alternative to using silicon oxide may be to create an active material with both silicon and silicon oxide characteristics and properties, by growing an oxide surface layer on silicon. For example, elemental silicon may be oxidized to develop a native oxide surface layer under certain ambient conditions. Such native oxide surface layer may be thin-e.g., a few nanometers thick. Conventionally, silicon (e.g., silicon wafers) may be oxidized using methods such as: (i) dry oxidation in presence of oxygen at high temperatures (e.g., >700° C.), and (ii) wet oxidation in presence of water vapor at lower temperatures (e.g., >400° C.). In this regard, different dry and wet oxidation processes may affect the thickness and density of resulting oxide films on the surface of silicon wafers.

In accordance with the present disclosure, silicon oxidization may be achieved instead using an acid-based wet oxidation for creating porous oxide layer on silicon particles. In this regard, when pyrolyzed with a carbon precursor as a binder, the carbon precursor reacts with silicon particles at temperatures >800° C. to form a porous silicon carbide layer that should help in reducing particle pulverization and thus help in improving cycling performance of lithium-ion cells/batteries. Instead, in implementations based on the present disclosure, silicon particles may be oxidized at room temperature using wet oxidation technique which employs a strong oxidizer, such as acids. In this regard, chemical silicon oxide layers formed in this manner may yield improved interface characteristics-e.g., low(er) interface state density and/or smooth(er) Si/SiO₂ interface. For example, silicon powders with D50 diameters-that is, roughly between 1 µm and 20 µm-may have weight increase of more than 5% when chemical silicon oxide layers are formed vs less than 5% with just heating in air.

For example, in various implementations, nitric acid may be used as the oxidizer agent in wet oxidation of silicon particles. In this regard, chemical silicon oxide layers formed using nitric acid may have the lowest interface state density and smoothest Si/SiO₂ interface among the chemical oxide layers formed using acids, particularly those formed using HNO₃, HCl+H₂O₂, and H₂SO₄ +H₂O₂. Further, compared to solutions based on oxidizing silicon particles using oxygen or water in a fluidized bed system, oxidation with nitric acid may require lower reaction temperatures-e.g., ~25° C. with nitric acid compared to >700° C. for water or >900° C. for oxygen.

In an example nitric acid based treatment, silicon powder, with an average particle size of 10 µm, may be immersed in 67% nitric acid and dispersed continuously. After the immersion period, the silicon powder may be filtered from the nitric acid, and rinsed with water to remove nitric acid residue. Nonetheless, it should be understood that the disclosure is not limited to the specific parameters (particle size, acid concentration, duration of immersion, etc.) disclosed herein. For example, the particle size may be in the range of 5 µm to 15 µm, or in the range of 1 µm to 20 µm. The acid concentration may be varied, such as in the range of 20% to 68%. Further, the duration of immersion may be varied, such as in the range of 1 minute to 1 hour, or 1 hour to 24 hours.

The nitric acid based treatment, with the parameters noted above, may result in silicon that is 56% by weight of the total dispersion, for example. In an example use case, three different samples may be produced, using three different total durations of immersions-e.g., with the total duration of immersion being 5 minutes, 1 hour, and 48 hours for the three samples, respectively. After the immersion period, the powder samples were filtered from the nitric acid, and rinsed with water to remove nitric acid residue.

The chemical silicon oxide layers are thicker than oxide layers formed through other methods with the thickness of the layer being higher than 2 nm, 3 nm, 5 nm, 10 nm, 30 nm, or around 50 nm, such as depending on the original silicon native layer thickness and process used (e.g., concentration and length of treatment).

The nitric acid treated silicon, and attributes and/or characteristics thereof, may be evaluated, particularly in comparison to control silicon. In this regard, the control silicon may be untreated silicon and/or silicon that was rinsed with water. For example, surface characteristics of nitric acid treated silicon particles may be assessed, such as based on Brunauer-Emmett-Teller (BET) data. In an example test, Brunauer-Emmett-Teller (BET) data are obtained for all of the samples-that is, both nitric acid treated silicon samples and the control samples. If the BET data are found to be close, e.g., within ±5% of 0.6 m²/g, this indicates that formed oxide film may be too thin to be reliably measured for its various properties by the BET, and is likely a few nanometers thick.

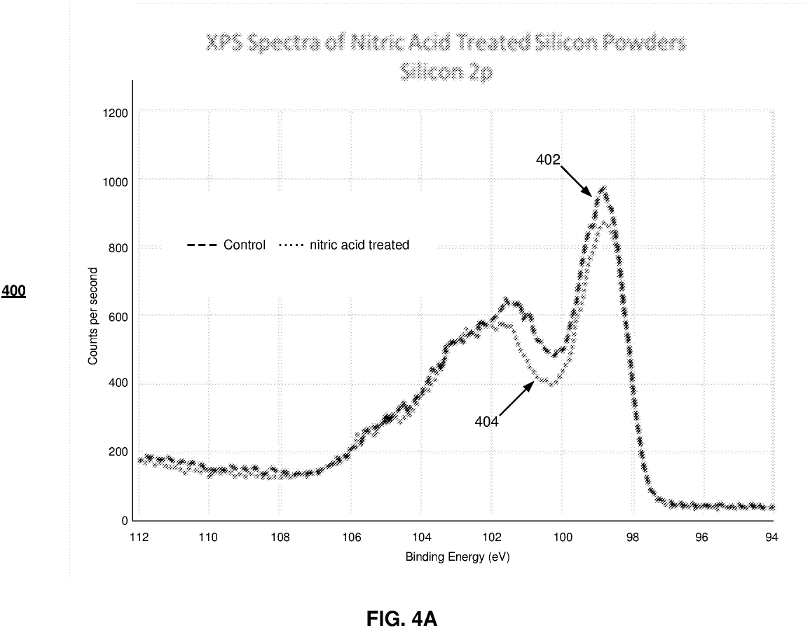

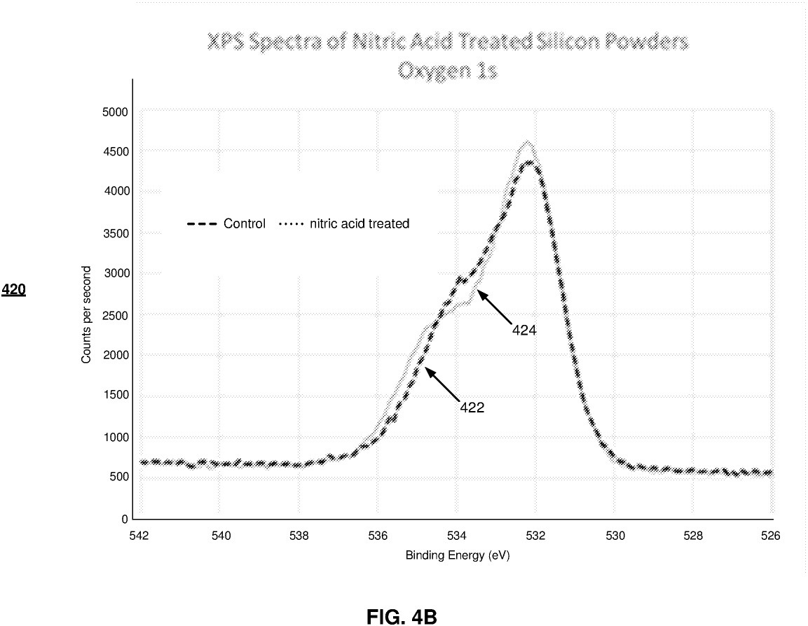

Surface characteristics of nitric acid treated silicon particles may also be evaluated using suitable examination methods, such as X-ray Photoelectron Spectroscopy (XPS), as described in more detail with respect to FIGS. 4A and 4B.

The nitric acid treated silicon may be used in forming anodes and subsequently cells/batteries incorporating these anodes. In an example implementation, the anode may be developed by dispersing the treated silicon into a slurry containing NMP as solvent, and polyamic acid resin as a pyrolyzed carbon precursor. The slurry may then be coated onto a PET film at a loading of 3.63 mg/cm2 (with 15% solvent content) and densified using a calender. The green film may then be removed from the PET, cut into sheets, and vacuum dried using a two-stage process (e.g., 120° C. for 15 h, 220° C. for 5h). The dry film may be thermally treated (e.g., at 1175° C.) to convert the polymer matrix into carbon. Separately, a thick copper foil (e.g., 15 µm) may coated with polyamide-imide (e.g., applied as an 8 wt% varnish in NMP, dried 16 h at 110° C. under vacuum). The silicon-carbon composite film may then be laminated to the coated copper using a heated hydraulic press (50 seconds, 300° C., and 4000 psi), forming the finished silicon-composite electrode.

The silicon-carbon composite electrodes may then be used in forming a cell. For example, the developed silicon-carbon composite electrodes as described above may be assembled into lithium-ion cells comprising the silicon-carbon composite anode(s) as well as cathode(s), separator(s), and an electrolyte solution. In an example implementation, cathodes may be comprised of 15 µm aluminum foil coated with a 23 mg/cm², 3.02 g/cc film comprising 92% NCM622, 4% conductive carbon additive, and 4% polyvinylidene difluoride (PVDF). The separator may be a 16 µm porous polypropylene membrane, coated with 3.5 µm thick films consisting of a mixture of PVDF and Poly(methyl methacrylate) (PMMA). The electrolyte solution may comprise 1.2 M LiPF6 in organic carbonates. The cell design may have a nominal capacity of 700 mAh at full voltage window.

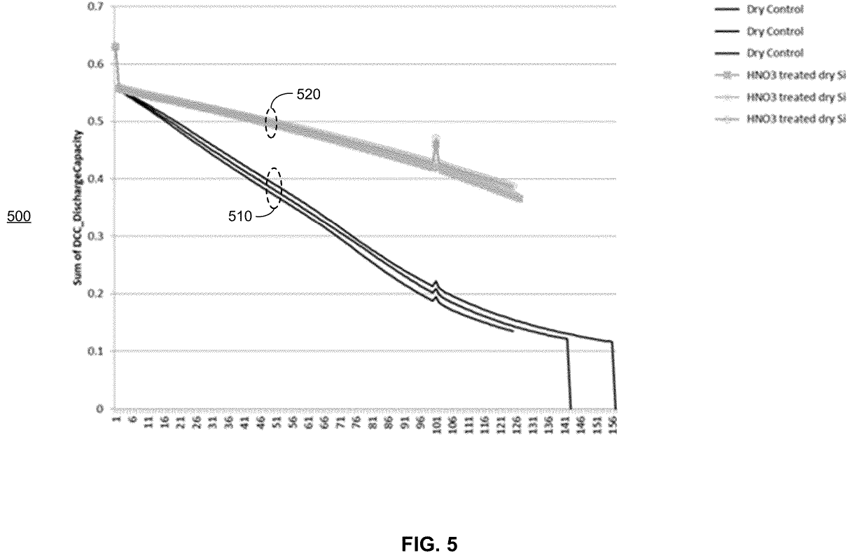

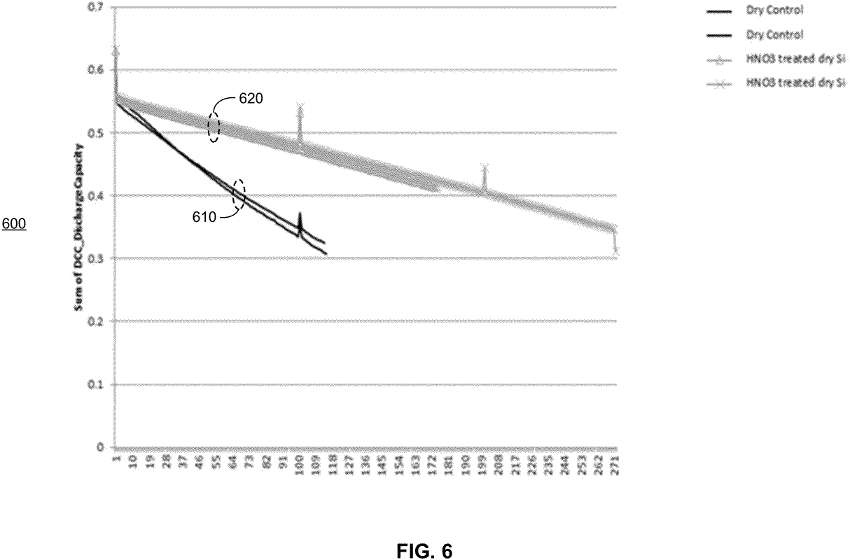

Performance of the electrodes and cell/batteries using the nitric acid treated silicon may be assessed, particularly in comparison to cells/battering comprising control anodes-that is, anodes that use control silicon. For example, cells with the design described above (including anodes with nitric acid treated silicon or anode with controlled silicon) may be tested using constant current/constant voltage charge profiles and constant current discharge profiles. This is described in more detail with respect to FIGS. 5 and 6.

FIGS. 4A and 4B are graph diagrams illustrating X-ray Photoelectron Spectroscopy (XPS) spectra for silicon powders with untreated silicon particles and nitric acid treated silicon particles. Shown in FIGS. 4A and 4B are graphs 400 and 420.

The graphs 400 and 420 illustrate oxide characterization data as obtained using X-ray Photoelectron Spectroscopy (XPS), which may allow generating information characterizing surfaces of the silicon powder samples undergoing different durations of nitric acid treatments. The XPS spectra for each sample may be taken on multiple areas of the sample and averaged to minimize the effect of location variation. In addition, the peak locations may be charge corrected, such as by shifting the Carbon 1 s (C 1 s) binding energy to the standard 284.8 eV for all spectra.

The graphs 400 and 420 show the averaged XPS spectra for silicon 2p (Si 2p) and Oxygen 1 s (O 1 s) peaks, respectively, for the different powder samples produced by the various nitric acid treatments. In particular, lines 402 and 422 capture XPS data of control silicon whereas lines 404 and 424 capture XPS data of nitric acid treated silicon. As illustrated in graphs 400 and 420, XPS data shows subtle differences between samples, demonstrating that the different nitric acid techniques influence surface oxide layer composition and thickness.

FIG. 5 is a graph diagram illustrating cycling performance of anodes with nitric acid treated silicon compared with control anodes when using 4C(4.2 V)/0.5C(3.1 V) testing regime. Shown in FIG. 5 is graph 500.

The graph 500 illustrates results of testing of example silicon-dominant anode based cells over a number of cycles (life cycle), specifically capturing discharge capacity of the cells as a function of cycle number. The cells may comprise either anodes with nitric acid treated silicon or control anodes-that is, anodes with control silicon. The cells may be tested under the same cycling conditions-namely, cycles of charging to 4.2 V at 4 C and discharging to 3.1 V at 0.5 C (i.e., 4 C(4.2 V)/0.5 C(3.1 V) cycles) using the testing regime described in the table below:

TABLE 1

the 4C(4.2V)/0.5C(3.1V) testing regime

| Cycle No. | Details |
|---|---|
| 1 | Charge at 0.33 C to 4.2 V until 0.05 C, rest 5 minutes, discharge at 0.33 C to 3 V, rest 5 minutes |
| 2 | Charge at 4 C to 4.2 V until 0.05 C, rest 5 minutes, discharge at 0.5 C to 3.1 V, rest 5 minutes |
| 3-100 | Same as Cycle 2 |
| 101 | Same as Cycle 1 |
| 102-200 | Same as Cycle 2 |
| 201 | Same as Cycle 1 |
| 202-300 | Same as Cycle 2 |

As shown in FIG. 5, in graph 500, line(s) 510 correspond to testing of cells with a control anode (e.g., with dry silicon), whereas line(s) 520 correspond to testing of cells with nitric acid treated anodes. As illustrated by graph 500 the nitric acid treated anodes exhibit improved cycling performance compared with the control anodes as tested in accordance with the 4 C(4.2 V)/0.5 C(3.1 V) testing regime.

FIG. 6 is a graph diagram illustrating cycling performance of anodes with nitric acid treated silicon compared with control anodes when using 1 C(4.2 V)/0.5 C(3.1 V) testing regime. Shown in FIG. 6 is graph 600.

The graph 600 illustrates results of testing of example silicon-dominant anode based cells over a number of cycles (life cycle), specifically capturing discharge capacity of the cells as a function of cycle number. The cells may comprise either anodes with nitric acid treated silicon or control anodes-that is, anodes with control silicon. The cells may be tested under the same cycling conditions-namely, cycles of charging to 4.2 V at 1 C and discharging to 3.1 V at 0.5 C (i.e., 1 C(4.2 V)/0.5 C(3.1 V) cycles) using the testing regime described in the table below:

TABLE 2

the 1 C(4.2 V)/0.5 C(3.1 V) testing regime

| | |
|---|---|
| Cycle No. | Details |
| 1 | Charge at 0.33 C to 4.2 V until 0.05 C, rest 5 minutes, discharge at 0.33 C to 3 V, rest 5 minutes |
| 2 | Charge at 1 C to 4.2 V until 0.05 C, rest 5 minutes, discharge at 0.5 C to 3.1 V, rest 5 minutes |
| 3-100 | Same as Cycle 2 |
| 101 | Same as Cycle 1 |
| 102-200 | Same as Cycle 2 |
| 201 | Same as Cycle 1 |
| 202-300 | Same as Cycle 2 |
| ... | ... |

As shown in FIG. 6, in graph 600, line(s) 610 correspond to testing of cells with control anode (e.g., with dry silicon), whereas line(s) 620 correspond to testing of cells with nitric acid treated anodes. As illustrated by graph 600 the nitric acid treated anodes exhibit improved cycling performance compared with the control anodes as tested in accordance with the 1 C(4.2 V)/0.5 C(3.1 V) testing regime.

Example treated silicon, in accordance with the present disclosure, for use in an electrode in an electrochemical cell, comprises silicon particles, wherein each silicon particle comprises an oxide surface layer formed using wet oxidization treatment of untreated silicon using an acid.

In an example embodiment, the acid comprises nitric acid.

In an example embodiment, the oxide surface layer comprises one or more of silicon monoxide (SiO), silicon dioxide (SiO2), or silicon oxide (SiOx).

In an example embodiment, the oxide surface layer has a thickness of no more than 100 nanometers.

In an example embodiment, the oxide surface layer has lower interface state density compared to control silicon, the control silicon comprising one or both of untreated silicon and silicon treated with water.

In an example embodiment, the oxide surface layer has smoother interface density compared to control silicon, the control silicon comprising one or both of untreated silicon and silicon treated with water.

In an example embodiment, an average particle size of the silicon particles is from about 0.1 µm to about 40 µm.

In an example embodiment, the oxide surface layer is a substantially continuous layer.

In an example embodiment, the silicon particles are from about 90% pure silicon to about 99% pure silicon.

An example electrode, in accordance with the present disclosure, for use in an electrochemical cell comprises silicon particles, wherein each silicon particle comprises an oxide surface layer formed using wet oxidization treatment of untreated silicon using an acid.

In an example embodiment, the acid comprises nitric acid.

In an example embodiment, the oxide surface layer comprises one or more of silicon monoxide (SiO), silicon dioxide (SiO2), or silicon oxide (SiOx).

In an example embodiment, the oxide surface layer has a thickness of no more than 100 nanometers.

In an example embodiment, the oxide surface layer has lower interface state density compared to control silicon, the control silicon comprising one or both of untreated silicon and silicon treated with water.

In an example embodiment, the oxide surface layer has smoother interface density compared to control silicon, the control silicon comprising one or both of untreated silicon and silicon treated with water.

In an example embodiment, an average particle size of the silicon particles is from about 0.1 µm to about 40 µm.

In an example embodiment, the oxide surface layer is a substantially continuous layer.

In an example embodiment, the silicon particles are from about 90% pure silicon to about 99% pure silicon.

An example method, in accordance with the present disclosure, of preparing silicon for use in an electrode in an electrochemical cell comprises immersing untreated silicon powder in an acid, dispersing the silicon powder continuously, and after an immersion period, filtering the silicon powder from the acid.

In an example embodiment, the method further comprises, after the filtering, rinsing the silicon powder with water to remove acid residue.

In an example embodiment, the acid comprises nitric acid.

In an example embodiment, the nitric acid has concentration of 67%.

In an example embodiment, the immersion period has a pre-determined duration.

In an example embodiment, the immersion period has a duration of 5 minutes, 1 hour, or 48 hours.

In an example embodiment, an average particle size of silicon particles in the silicon powder is from about 0.1 µm to about 40 µm.

In an example embodiment, an average particle size of the silicon particles in the silicon powder is from about 5 µm to about 15 µm.

In an example embodiment, an average particle size of the silicon particles in the silicon powder is 10 µm.

In an example embodiment, the silicon powder comprises silicon particles that are from about 90% pure silicon to about 99% pure silicon.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. Treated silicon for use in an electrode in an electrochemical cell, comprising:
silicon particles,
wherein each silicon particle comprises an oxide surface layer formed using wet oxidization treatment of untreated silicon using an acid, and
wherein the silicon particles have, as a result of the wet oxidization treatment using the acid, a weight increase that is higher than a weight increase in silicon particles of a same size as a result of oxidization by one or more other treatments, the one or more other treatments comprising, at least, oxidation by interaction with ambient oxygen.

2. The treated silicon of claim 1, wherein the acid comprises nitric acid.

3. The treated silicon of claim 1, wherein the oxide surface layer comprises one or more of silicon monoxide (SiO), silicon dioxide (SiO2), or silicon oxide (SiOx).

4. The treated silicon of claim 1, wherein the oxide surface layer has a thickness of no more than 100 nanometers.

5. The treated silicon of claim 1, wherein the oxide surface layer has lower interface state density compared to control silicon, the control silicon comprising one or both of untreated silicon and silicon treated with water.

6. The treated silicon of claim 1, wherein the oxide surface layer has smoother interface density compared to control silicon, the control silicon comprising one or both of untreated silicon and silicon treated with water.

7. The treated silicon of claim 1, wherein an average particle size of the silicon particles is from about 0.1 µm to about 40 µm.

8. The treated silicon of claim 1, wherein the oxide surface layer is a substantially continuous layer.

9. The treated silicon of claim 1, wherein the silicon particles are from about 90% pure silicon to about 99% pure silicon.

10. An electrode for use in an electrochemical cell, the electrode comprising:
silicon particles,
wherein each silicon particle comprises an oxide surface layer formed using wet oxidization treatment of untreated silicon using an acid, and
wherein the silicon particles have, as a result of the wet oxidization treatment using the acid, a weight increase that is higher than a weight increase in silicon particles of a same size as a result of oxidization by one or more other treatments, the one or more other treatments comprising, at least, oxidation by interaction with ambient oxygen.

11. The electrode of claim 10, wherein the acid comprises nitric acid.

12. The electrode of claim 10, wherein the oxide surface layer comprises one or more of silicon monoxide (SiO), silicon dioxide (SiO2), or silicon oxide (SiOx).

13. The electrode of claim 10, wherein the oxide surface layer has a thickness of no more than 100 nanometers.

14. The electrode of claim 10, wherein the oxide surface layer has lower interface state density compared to control silicon, the control silicon comprising one or both of untreated silicon and silicon treated with water.

15. The electrode of claim 10, wherein the oxide surface layer has smoother interface density compared to control silicon, the control silicon comprising one or both of untreated silicon and silicon treated with water.

16. The electrode of claim 10, wherein an average particle size of the silicon particles is from about 0.1 µm to about 40 µm.

17. The electrode of claim 10, wherein the oxide surface layer is a substantially continuous layer.

18. The electrode of claim 10, wherein the silicon particles are from about 90% pure silicon to about 99% pure silicon.

19. A method of preparing silicon for use in an electrode in an electrochemical cell, the method comprising:
immersing untreated silicon powder in an acid;
dispersing the silicon powder continuously; and
after an immersion period, filtering the silicon powder from the acid.

20. The method of claim 19, further comprising, after the filtering, rinsing the silicon powder with water to remove acid residue.

21. The method of claim 19, wherein the acid comprises nitric acid.

22. The method of claim 21, wherein the nitric acid has concentration of 67%.

23. The method of claim 19, wherein the immersion period has a predetermined duration.

24. The method of claim 23, wherein the immersion period has a duration of 5 minutes, 1 hour, or 48 hours.

25. The method of claim 19, wherein an average particle size of silicon particles in the silicon powder is from about 0.1 µm to about 40 µm.

26. The method of claim 19, wherein an average particle size of the silicon particles in the silicon powder is from about 5 µm to about 15 µm.

27. The method of claim 19, wherein an average particle size of the silicon particles in the silicon powder is 10 µm.

28. The electrode of claim 19, wherein the silicon powder comprises silicon particles that are from about 90% pure silicon to about 99% pure silicon.

29. The treated silicon of claim 1, wherein the silicon particles have, as a result of the wet oxidization treatment using the acid, an oxide film that is thicker than an oxide film on silicon particles of a same size as a result of oxidization by the one or more other treatments.

30. The electrode of claim 10, wherein the silicon particles have, as a result of the wet oxidization treatment using the acid, an oxide film that is thicker than an oxide film on silicon particles of a same size as a result of oxidization by the one or more other treatments.
